(19) United States
(12) Patent Application Publication
(10) Pub. No.: US 2004/0224828 A1
(43) Pub. Date: Nov. 11, 2004

(54) Method of and apparatus for the grooving of endless webs

(75) Inventor: Wilhelm Nelles, Heiden (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hotten Maschinenbau GmbH

(21) Appl. No.: 10/776,920

(22) Filed: Feb. 10, 2004

(30) Foreign Application Priority Data
Feb. 13, 2003 (DE) 10306210.6

(51) Int. Cl. B31B 1/25

(52) U.S. Cl. 493/59

(57) ABSTRACT

A method of and an apparatus for the grooving of foldable material, especially corrugated paper in which grooves are formed alternately on opposite sides of the foldable material at spacings enabling the folding thereof, for example, in to an accordion folding package.

### FIELD OF THE INVENTION

My present invention relates to a method of and to an apparatus for the grooving of a foldable material, especially paper and, more particularly, to an endless or continuous web of paper. More particularly, the invention relates to the formation by an embossing process of grooves in a continuous web of paper which cannot be readily rolled and which may be required to be accordion folded, especially one or single corrugated or multicorrugated paper which can have cover layers on opposite sides thereof. The invention also relates to an apparatus for embossing the web with such grooves.

### BACKGROUND OF THE INVENTION

Endless or continuous webs of foldable material, especially papers which cannot be readily rolled up or bent, are frequently subjected to accordion folding to produce a stack of interconnected panels. This applies especially to single-corrugated or single layer corrugated paper or multilayer corrugated paper or paper board and to corrugated papers in which a corrugated core is flanked by cover sheets.

In the past, in the production of accordion folded stacks of such mat rial, it has been common to provide the web at equidistant intervals with transverse grooves. The transverse grooves then serve as fold lines so that one panel could be folded over the other at each groove. The grooves were formed by periodically impacting the web with a bar, the bar generally is applied to the web or one side only so all of the grooves were on the same side of the web.

In subsequent folding of the web to provide an accordion folded stack of the interconnected panels, it was found that the folding in such cases often was not clean and the result could be a ragged stack.

### OBJECTS OF THE INVENTION

It is, therefore, the principal object of the invention to provide an improved method of grooving a continuous web of a foldable and not readily bendable material, whereby subsequent accordion folding can be cleaner and more precise.

It is another object of the invention to provide an improved method of processing corrugated paper so as to improve the subsequent accordion folding thereof.

Still another object is to provide an improved apparatus for grooving a corrugated or other foldable and not readily bendable sheet material.

### SUMMARY OF THE INVENTION

These objects and others which will become apparent hereinafter are attained in accordance with the present invention in a method of grooving a continuous or endless web of material, especially a material of the type described, whereby the grooves are formed alternately from opposite sides.

According to the invention, therefore, a web of a foldable material, especially an endless or continuous web of corrugated paper, is grooved at equispaced locations from opposite sides of the web. The spacing of the grooves from a groove on one side to a groove on the opposite side can correspond, preferably to the fold length of the material. The fold length can be equal to the length of the panels between the grooves.

Preferably the method and/or the apparatus operate continuously with a continuous advance of the web.

According to a feature of the invention, the apparatus for grooving the web comprises two counterrotating bodies (drums or rollers) each of which has a positive and a negative grooving tool spaced around the periphery of the body and juxtaposed, upon synchronous rotation of the bodies with the negative and positive tool, respectively, whereby the web is grooved from opposite sides. The spacing of the grooves, of course, then depends upon the diameter of each body and the spacing of the tools therealong.

The synchronization of the bodies can be effected by electronic coupling of the drive of the bodies and/or by means of gearing which can couple the bodies together.

In accordance with a feature of the invention, the axial spacing of the bodies is adjustable. The bodies, moreover, can be mounted on arms which may be interconnected by scissor linkage so that an opening angle of the arms is variable. The variation in the axial spacing may be effected by a threaded spindle which can adjust the opening angle of the arms.

The grooving tool and/or the groove tool carrier may be radially shiftable upon the respective body and the radial shifting can be effected via toothed racks or toothed rack segments or threaded spindles.

The bodies can comprise rectangular base structures with shaft stubs at their ends. The respective grooving tools can be mounted on L-shaped tool carriers or can be formed in one position therewith. The L-shaped tool carrier can be positioned radially on the respective bodies by means of wedge-shaped clamping plates which are shiftable in the direction of the axis of the body and can be anchored in position.

Additional feed rollers can be provided for the webs and the rotation of the embossing bodies and feed rollers can be synchronized with one another, the synchronization to be effected electronically or by means of gearing. The axial spacing of the two bodies or feed rollers can be variable.

### BRIEF DESCRIPTION OF THE DRAWING

The above and other objects, features, and advantages will become more readily apparent from the following description, reference being made to the accompanying drawing in which:

FIG. 1 is a diagrammatic side view showing the embossing rollers of the invention;

FIG. 2 is a view similar to FIG. 1 of a second embodiment;

FIG. 3 is a diagram showing the formation of grooves from opposite sides in a corrugated paper web; and

FIG. 4 is a diagram illustrating the accordion folding of the web.

### SPECIFIC DESCRIPTION

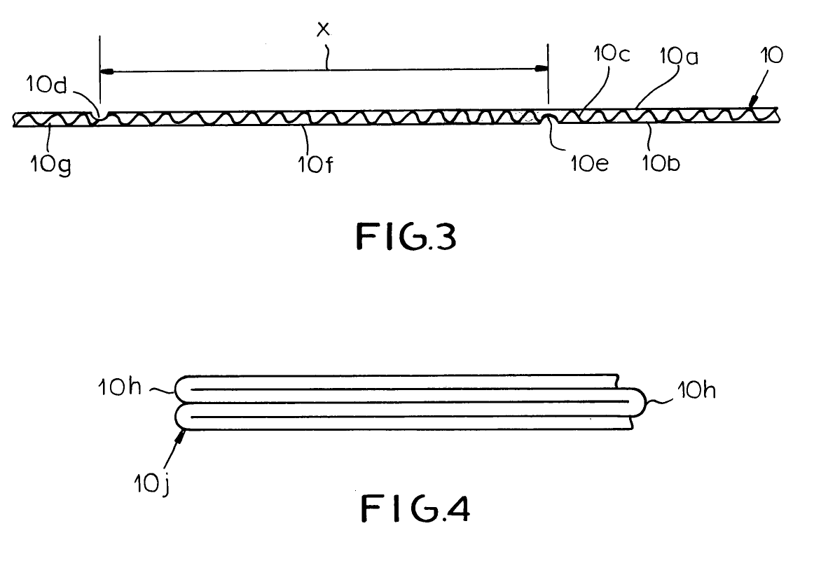

Referring first to FIG. 3 it can be seen that a corrugated paper sheet can have an upper paper layer 10a and a lower paper layer 10b sandwiching the corrugated layer 10c between them. At a spacing x, grooves 10d and 10e are impressed into the web 10 from opposite sides to define panels 10f, 10g, respectively. The grooves 10d and 10e facilitate folding of the web at the folds 10h (FIG. 4) so that the panels can lie one on top of the other in an accordion folded package 10j (FIG. 4).

The grooves can be embossed in the workpiece by two counterrotating grooving rollers or drums 1, 2, each of which is provided with a positive grooving tool 11 or 21 and a negative grooving tool 12 or 22. A positive grooving tool has a ridge 11a which can be impressed in the web to form the groove 10d or 10e, while the negative grooving tool may have a recess 22a to partly receive the ridge of the opposite grooving tool. The grooving tools are provided on the periphery of the rollers 1 and 2 in spaced-apart relationship and the rollers are rotated synchronously so that negative and positive pairs of tools will engage the workpiece at least on every rotation of the rollers. The length of the web between grooves depends, of course, on the desired fold length and the spacing of the tools on the rollers.

As for the negative grooving tools 12 and 22, it will be understood that these tools may also be flat, i.e. not contoured, depending upon the groove shape desired in the web. The advantage of a negative grooving tool is that it can ensure proper alignment of the positive grooving tool.

In the illustrated embodiment the radius of the grooving tool 11, 12, 21, 22 on the grooving roller 1, 2 is variable and can be adjusted to lie in any of, for example, three circles 60, 61, 62. They are not however limited to the three positions represented by these circles and indeed can be infinitely positionable between the innermost and outermost circles. This advantageous embodiment makes it possible to arbitrarily adjust the spacing of tools along the periphery and thus the spacing of grooves.

For this positioning, each of the rollers can have a pinion 60a which can engage a respective rack 60b, 60c which can carry the L-shaped support 101, 102, for example, on which the tool 11 or 12 my be mounted. Rotation of the pinion 60a will, of course, adjust the radial position of the respective tool which can then be locked by bolts 60d passing between plates 60e through longitudinal grooves in the respective racks.

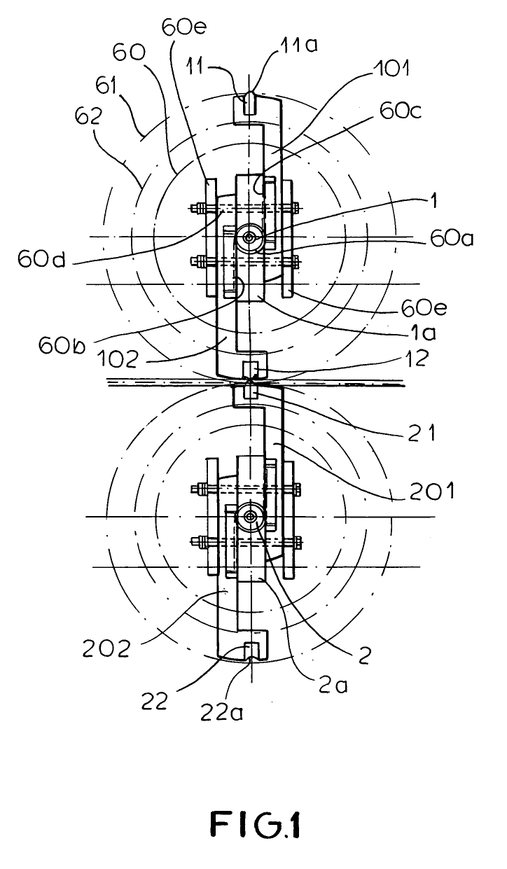

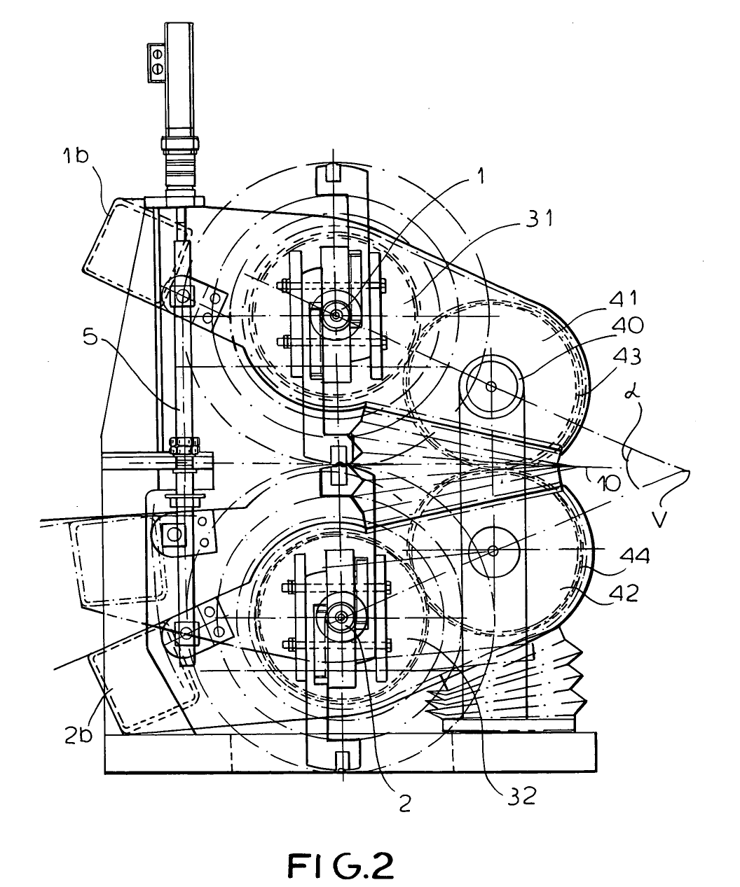

The positive and negative tools 11, 12, 21, 22 are replaceably mounted on the tool carriers 101, 102, 201, 202 although they can be formed in one piece thereof. As an alternative rack and pinion adjustment, a threaded spindle can be provided for the radial adjustment of the tools in the embodiments of FIGS. 1 and 2.

The rollers 1, 2 have base bodies 1a, 2a which are rectangular and can be provided at their ends with shaft stubs. To guarantee that the tool carriers will be fixed in position radially, clamping plates can be provided which can be wedge shaped and can be driven between the bodies 1a and 2a and the respective tool holders.

Any number of tool holders providing respective positive and negative tool pairs can be provided.

A further embodiment has been shown in FIG. 2 in which the grooving rolls 1 and 2 are journaled on arms 1b and 2b which have a scissor linkage with one another represented by the vertex V of the opening triangle at angle a shown in FIG. 2. The opening and closing of the arms and this variation in the axial spacing of the rollers 1, 2, is effected by means of at least one threaded spindle 5. Alternatively the opening of the arms can be adjusted by hydraulic means. This adjustment allows the tools to be positioned to groove different thicknesses of the web. The synchronization of the rolls 1, 2 can be effected by electronic coupling of separate drives for the members 1 and 2 or by means of gear wheels 31, 32, 41, 42 which interconnect the rollers. The drive in the form of a motor is connected to the gear 41 as represented at 40 at in FIG. 2.

In addition to the rollers 1 and 2, rollers 43 and 44 can be provided to feed the web 10 through the embossing machine and the rollers 43 and 44 may be connected to the gears 41 and 42 thereby synchronizing them with the rollers 1 and 2. The axial spacing of the feed rollers 43 and 44 can likewise be adjustable to accommodate differing thicknesses of the web 10.

The web 10 is fed through the devices of FIGS. 1 and 2 and is thereby grooved alternately on opposite sides as has been described with respect to FIGS. 3 and 4.

I claim:

1. A method of grooving a web of a foldable material which comprises the steps of:
advancing a continuous web of a foldable material along a path; and
impressing a succession of grooves into said foldable material at a location along said path alternately from opposite sides of said web.

2. The method defined in claim 1, further comprising the step of folding said web at folds spaced apart corresponding to the spacing of two grooves on opposite sides of said web.

3. The method defined in claim 1 wherein the grooving of the foldable material is effected during continuous advance of the foldable material.

4. An apparatus for grooving a web of foldable material to form spaced apart grooves on opposite sides of said web alternately, said apparatus comprising:
a pair of rotating bodies having said web passing between them;
a positive and a negative grooving tool on each of said bodies positioned to register with one another so that said web is impressed between a positive and a negative tool on each side of said web alternately to form grooves in said web alternately from opposite sides; and
means for synchronizing rotation of said bodies with one another.

5. The apparatus defined in claim 4 wherein the bodies are synchronized by electronic coupling of respective drives or by means of gearing.

6. The apparatus defined in claim 4, further comprising means for passing an axial spacing of said bodies.

7. The apparatus defined in claim 6 wherein said bodies are mounted on a pair of arms defining a variable opening angle between them.

8. The apparatus defined in claim 7, further comprising at least one threaded spindle between said arms for adjusting the axial spacing of said body.

9. The apparatus defined in claim 4 wherein said tools are variably displaceable radially on said bodies.

10. The apparatus defined in claim 9 wherein said tools are radially shiftable relative to one another by respective toothed racks.

11. The apparatus defined in claim 9 wherein the radial shifting of said tool is effected by at least one threaded spindle.

12. The apparatus defined in claim 4 wherein each of said bodies is a rectangular body having shaft stubs at opposite ends thereof.

13. The apparatus defined in claim 4 wherein each of said tools is formed on an L-shaped tool carrier.

14. The apparatus defined in claim 9 wherein each of said bodies comprises at least one pair of oppositely disposed L-shaped tool carriers.

15. The apparatus defined in claim 4, further comprising respective wedge-shaped clamping plates shiftable in a direction of the axis of the respective body for securing the respective tool in place.

16. The apparatus defined in claim 4, further comprising feed rollers engaging said web for advancing same.

17. The apparatus defined in claim 16 wherein said feed rollers are synchronized in rotation with said bodies.

18. The apparatus defined in claim 17 wherein said feed rollers are synchronized with said bodies by electronic synchronization circuitry for drives of said bodies and said feed roller or by gearing.

19. The apparatus defined in claim 4 wherein an axial spacing of said feed rollers is adjustable.
